(19) United States
(12) Patent Application Publication
(10) Pub. No.: US 2026/0303201 A1
(43) Pub. Date: Oct. 1, 2026

(54) APPARATUS AND METHOD FOR SUPPORTING COMMUNICATION USING USER PLANE FUNCTION ONBOARD SATELLITE IN WIRELESS COMMUNICATION SYSTEM

(71) Applicant: ELECTRONICS AND TELECOMMUNICATIONS RESEARCH INSTITUTE, Daejeon (KR)

(72) Inventors: Yoo Hwa KANG, Daejeon (KR); Namseok KO, Daejeon (KR); Seung Ik LEE, Daejeon (KR)

(73) Assignee: ELECTRONICS AND TELECOMMUNICATIONS RESEARCH INSTITUTE, Daejeon (KR)

(21) Appl. No.: 19/630,395

(22) Filed: Mar. 26, 2026

(30) Foreign Application Priority Data
Mar. 28, 2025 (KR) 10-2025-0040157
May 9, 2025 (KR) 10-2025-0060502
Feb. 19, 2026 (KR) 10-2026-0030946

(51) Int. Cl. H04B 7/185

(52) U.S. Cl. CPC H04B 7/18513

(57) ABSTRACT

Provided is a method for communication between pieces of non-Internet protocol multimedia subsystem (IMS) service based user equipment (UEs) using a user plane function (UPF) onboard a satellite in a wireless communication system. The operating method of the satellite includes receiving user plane traffic from a first UE, terminating the user plane traffic using the UPF onboard the satellite, and directly delivering the user plane traffic to a second UE based on an Internet protocol (IP) or Ethernet type of protocol data unit (PDU) session. The UPF operates as a PDU session anchor (PSA) and processes the user plane traffic without passing through a terrestrial data network (DN) or an IMS.

### CROSS-REFERENCE TO RELATED APPLICATIONS

This application claims priority under 35 U.S.C. § 119 to Korean Patent Application No. 10-2025-0040157 filed on Mar. 28, 2025, No. 10-2025-0060502 filed on May 9, 2025, and No. 10-2026-0030946 filed on Feb. 19, 2026, in the Korean Intellectual Property Office, the disclosures of which are incorporated by reference herein in their entireties.

### BACKGROUND

Embodiments of the present disclosure described herein relate to a wireless communication system, and more particularly, relate to an apparatus and a method for communication between pieces of non-IMS service based user equipment (UEs) using a user plane function (UPF) onboard a satellite in a wireless communication system.

A 5th generation system (5GC) is a method for providing a communication service even in an area where a ground-based network infrastructure is difficult to reach. The introduction of a non-terrestrial network (NTN) has been actively discussed. The 3rd generation partnership project (3GPP) performs standardization work for integrating the NTN into the 5GS from Rel-17. A satellite access technology is emerging as a core component.

An existing satellite communication system is mainly based on a communication structure between user equipment (UE) and a terrestrial gateway. In most cases, direct communication between UEs is not supported. Furthermore, an existing communication scheme has a structure in which a user plane function (UPF) is not onboard a satellite. The satellite is often limited simply to a role of a relay station. Such a structure may cause an increase in latency, deterioration in resource efficiency, restriction on quality of service, or the like.

An existing 5G network is designed to always pass through a terrestrial UPF between users. Particularly, when a satellite backhaul is used, unnecessary latency and a traffic bottleneck phenomenon occur. To address it, a geostationary earth orbit (GEO) satellite-based local switching scheme is described in Section 5.43.3.3 of the 3GPP TS 23.501 standard. In detail, a structure to directly deliver traffic between two UEs covered via the same GEO satellite in the satellite without passing through a terrestrial network, as an uplink classifier/branching point (UL CL/BP) and local PDU session anchor (L-PSA) UPF is onboard the GEO satellite is defined.

However, a non-geostationary satellite orbit (NGSO) satellite environment, for example, a low earth orbit (LEO) or medium earth orbit (MEO) satellite is characterized by rapid mobility and an inter-satellite link (ISL). There is a limitation in applying a GEO satellite-based fixed structure as it is. Thus, a local switching technology specialized for the NGSO environment is required, but there is no structure which is standardized or implemented up to now. 3GPP Rel-19 proceeds with standardization to provide an Internet protocol multimedia subsystem (IMS) service as the UPF is onboard the satellite in an NGSO based satellite network environment. However, according to 3GPP TS 23.501(Rel-19), there are constraints capable of providing only an IMS service between terminals via the satellite with the UPF.

Meanwhile, a communication service between non-IMS based UEs, for example, IP based messaging, file transfer, or the like, is generally provided based on the UPF and a protocol data unit (PDU) session in an existing 5GS. However, when such a service is provided via the satellite, it is difficult to efficiently establish a communication path between UEs in an existing structure. Particularly, there is a lack of consideration for a problem, such as a handover, a path change, or latency compensation capable of occurring on the satellite path.

Thus, the necessity of a new structure where communication between UEs is performed via a satellite based path (UE-SAT-UE), a UPF is onboard the satellite, and a termination point of the PDU session is located on the satellite is emerging. As a result, dependence on a terrestrial network may decrease and an independent communication path between UEs may be provided to improve continuity and efficiency of a service.

### SUMMARY

Embodiments of the present disclosure provide an apparatus and a method for establishing a low-latency direct communication path between pieces of user equipment (UEs) using a user plane function (UPF) onboard a satellite without passing through a terrestrial network in a non-geostationary satellite orbit (NGSO) satellite environment in a wireless communication system.

Embodiments of the present disclosure provide an apparatus and a method for supporting communication between UEs for a non-IMS service, such as a 5G-LAN, via an Internet protocol (IP) or Ethernet based protocol data unit (PDU) session which does not pass through an Internet protocol multimedia subsystem (IMS) in a wireless communication system.

Embodiments of the present disclosure provide an apparatus and a method for providing a comprehensive communication structure including local switching in a single satellite and N19 based traffic routing among a plurality of satellites in a wireless communication system.

Embodiments of the present disclosure provide an apparatus and a method for providing direct communication between UEs even while IP continuity using an uplink classifier/branching point (UL CL/BP) and local PDU session anchor (L-PSA) UPF onboard the satellite in a wireless communication system.

According to an embodiment, a satellite for supporting communication between pieces of user equipment (UEs) for a non-Internet protocol multimedia subsystem (IMS) in a wireless communication system may receive user plane traffic from first user equipment (UE), may terminate the user plane traffic using a user plane function (UPF) onboard the satellite, and may directly deliver the user plane traffic to a second UE based on an Internet protocol (IP) or Ethernet type of protocol data unit (PDU) session. The UPF may operate as a PDU session anchor (PSA) and may process the user plane traffic without passing through a terrestrial data network (DN) or an IMS.

According to an embodiment, a session management function (SMF) for supporting communication between pieces of user equipment (UEs) for a non-Internet protocol multimedia subsystem (IMS) service in a wireless communication system may receive a satellite ID of a satellite accessed by a first UE and a second UE from an access and mobility management function (AMF), may determine whether the first UE and the second UE are located within coverage of the same satellite or interconnected satellites, may insert an uplink classifier/branching point (UL CL/BP) and local protocol data unit (PDU) session anchor (L-PSA) UPF onboard the satellite, and may configure a destination filter-based packet detection rule (PDR) and a forwarding action rule (FAR) in a UL CL and an L-PSA. A PSA UPF located on the ground may maintain IP addresses of the first UE and the second UE.

According to an embodiment, a satellite for supporting communication between pieces of user equipment (UEs) for a non-Internet protocol multimedia subsystem (IMS) in a wireless communication system may include a transceiver and a processor operatively connected with the transceiver. The processor may receive user plane traffic from a first UE, may terminate the user plane traffic using a UPF onboard the satellite, and may directly deliver the user plane traffic to a second UE based on an IP or Ethernet type of PDU session. The UPF may operate as a PSA and may process the user plane traffic without passing through a terrestrial DN or an IMS.

According to an embodiment, an SMF for supporting communication between pieces of user equipment (UEs) for a non-IMS service in a wireless communication system may include a transceiver and a processor operatively connected with the transceiver. The processor may receive a satellite ID of a satellite accessed by a first UE and a second UE from an AMF, may determine whether the first UE and the second UE are located within coverage of the same satellite or interconnected satellites, may insert a UL CL/BP and L-PSA UPF onboard the satellite, and may configure a destination filter-based PDR and an FAR in a UL CL and an L-PSA. A PSA UPF located on the ground may maintain IP addresses of the first UE and the second UE.

### BRIEF DESCRIPTION OF THE FIGURES

The above and other objects and features of the present disclosure will become apparent by describing in detail embodiments thereof with reference to the accompanying drawings.

FIG. 1 illustrates an IMS satellite media plane optimization reference structure according to an embodiment of the present disclosure.

FIG. 2 illustrates an IMS session establishment procedure for optimized media routing activation according to an embodiment of the present disclosure.

FIG. 3 illustrates a schematic diagram of a system for processing user plane traffic between UEs using a UPF in a satellite according to an embodiment of the present disclosure.

FIG. 4 illustrates a schematic diagram of a system for processing user plane traffic between L-PSAs according to an embodiment of the present disclosure.

FIG. 5 illustrates a protocol stack structure between PSA UPFs onboard satellites for N19 based forwarding according to an embodiment of the present disclosure.

FIG. 6 illustrates an NGSO satellite based local switching structure according to an embodiment of the present disclosure.

FIG. 7 illustrates a location based fixed IP address allocation structure according to an embodiment of the present disclosure.

FIG. 8 illustrates a flowchart of an operating method of a satellite according to an embodiment of the present disclosure.

FIG. 9 illustrates a flowchart of an operating method of an SMF according to an embodiment of the present disclosure.

FIG. 10 illustrates a configuration of a satellite according to an embodiment of the present disclosure.

FIG. 11 illustrates a configuration of a network entity according to an embodiment of the present disclosure.

### DETAILED DESCRIPTION

Terms used in the present disclosure are used to merely describe specified embodiments and are not intended to limit the scope of another embodiment. The singular expression may include plural expressions unless the context clearly indicates otherwise. The terms used herein, which include technical or scientific terms, may have the same meaning that is generally understood by a person skilled in the art in the technical field described in the present disclosure. Terms defined in a general dictionary among the terms used in the present disclosure may be interpreted as the same or similar meaning as a contextual meaning of related technology, and unless clearly defined in the present disclosure, it is not interpreted in an ideal or excessively formal meaning. In some cases, even if terms are terms which are defined in the present disclosure, they may not be interpreted to exclude embodiments of the present disclosure.

A hardware access method will be described as an example in various embodiments of the present disclosure, which will be described below. However, because various embodiments of the present disclosure include a technology which uses both of hardware and software, they do not exclude a software-based access method.

Furthermore, in the detailed description and claims of the present disclosure, at least one of A, B, and C may refer to “only A”, “only B”, “only C”, or “any combination of A, B, and C”. Furthermore, “at least one of A, B, or C” or “at least one of A, B, and/or C” may refer to at least one of A, B, and C.

Hereinafter, the present disclosure relates to an apparatus and a method for communication between pieces of non-Internet protocol multimedia subsystem (IMS) service based user equipment (UEs) using a user plane function (UPF) onboard a satellite in a wireless communication system. In detail, the present disclosure describes a technology for using a UPF onboard a non-geostationary satellite orbit (NGSO) satellite as a protocol data unit (PDU) session anchor (PSA) to configure a direct communication path between UEs without passing through a terrestrial network and supporting local switching via an uplink classifier/branching point ((UL Cl/BP) and a local PSA (L-PSA) and traffic routing between N19 based satellites.

A term referring to a signal, a term referring to a channel, a term referring to control information, a term referring a network entity, a term referring to a component of a device, and the like, which are used in a description below, are exemplified for convenience of description. Thus, the present disclosure is not limited to terms described below and another term with the equivalent technical meaning may be used.

Furthermore, the present disclosure describes various embodiments using terms used in some communication specifications (e.g., 3rd generation partnership project (3GPP)). However, this is just an example for illustrative purposes. Various embodiments of the present disclosure are easily modified and applied even in another communication system.

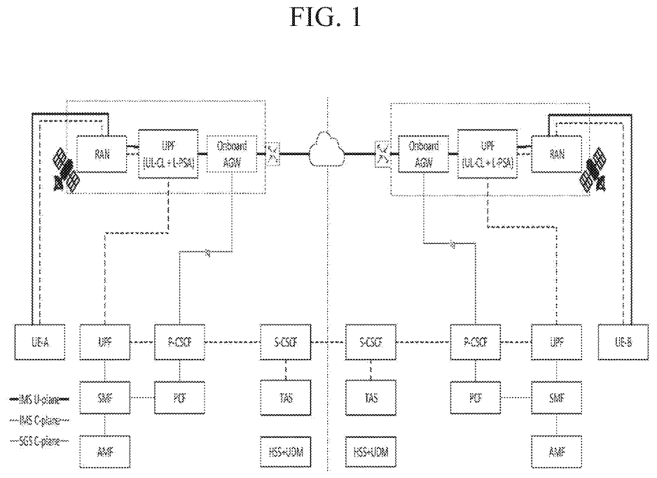

FIG. 1 illustrates an Internet protocol multimedia subsystem (IMS) satellite media plane optimization reference structure according to an embodiment of the present disclosure.

Referring to FIG. 1, an existing satellite based IMS service structure includes two satellites and terrestrial network elements. A radio access network (RAN), a user plane function (UPF) including an uplink classifier (UL CL) and a local protocol data unit (PDU) session anchor (L-PSA), and an onboard access gateway (AGW) are onboard each satellite.

In terms of a terrestrial network, each of first user terminal (UE) UE-A and a second UE UE-B is connected with a terrestrial UPF, a session management function (SMF), and an access and mobility management function (AMF). An IMS core network includes a proxy-call session control function (P-CSCF), a policy control function (PCF), a serving-call session control function (S-CSCF), a telephony application server (TAS), and home subscriber server/unified data management (HSS+UDM).

Sold lines in FIG. 1 indicate an IMS user plane (IMS U-plane) and dotted lines indicate an IMS control plane (IMS C-plane) and a 5th generation system control plane (5GS C-plane). As a connection between onboard AGWs is configured via an inter-satellite link (ISL) between two satellites, IMS media traffic between UE-A and UE-B may be directly delivered via the satellites without passing through a terrestrial network.

However, an existing structure illustrated in FIG. 1 is designed to support only an IMS based service and has a limitation in which direct communication between UEs for a non-IMS service is not supported. Furthermore, as signaling with complex IMS core network elements, such as the P-CSCF, the S-CSCF, and the TAS, is essentially required to establish an IMS session, it is not suitable for communication between UEs via an Internet protocol (IP) or Ethernet based simple PDU session.

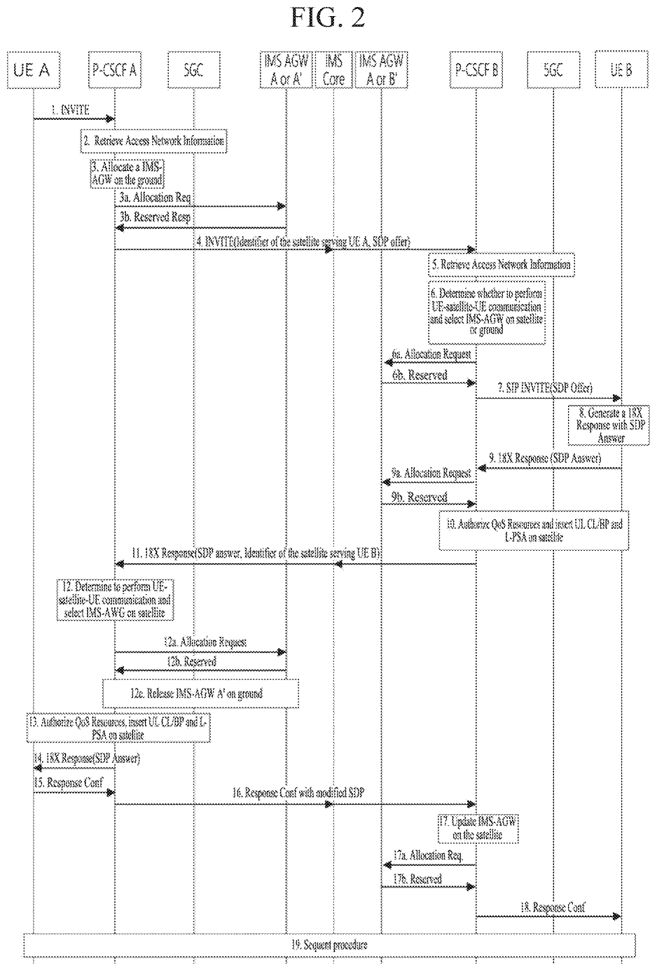

FIG. 2 illustrates an Internet protocol multimedia subsystem (IMS) session establishment procedure for optimized media routing activation according to an embodiment of the present disclosure.

Referring to FIG. 2, procedures for activating a satellite based optimized media path in an IMS session establishment process between user equipment (UE) A and UE B are sequentially performed. Network elements which participate in the procedure may include UE A, proxy-call session control function (P-CSCF) A, a 5th generation core (5GC), IMS access gateway (AGW) A or A′, an IMS core, IMS AGW A or B′, P-CSCF B, a 5GC, and UE B.

In step 1, UE A may transmit a session initiation protocol (SIP) INVITE message to start session establishment. In step 2, a network may retrieve access network information. In step 3, the IMS-AGW may be allocated on the ground. In steps 3a and 3b, an allocation request (Req) and a reservation response (Reserved Resp) may be exchanged.

In step 4, an INVITE message including an identifier of a satellite serving UE A and a session description protocol (SDP) offer may be delivered. In step 5, access network information may be retrieved. In step 6, it may be determined whether to perform UE-satellite-UE communication and an IMS-AGW on the satellite or ground may be selected. In steps 6a and 6b, allocation request and reservation (Reserved) may be performed.

In step 7, an SIP INVITE (SDP Offer) may be transmitted. In step 8, an 18X response with an SDP answer may be generated. In step 9, an 18X response (SDP answer) may be transmitted. In steps 9a and 9b, additional resource allocation may be performed. In step 10, quality of service (QoS) resources may be authorized and an uplink classifier/branching point (UL CL/BP) and a local PDU session anchor (L-PSA) may be inserted on the satellite.

In step 11, an 18X response with an identifier of a satellite serving UE B and an SDP answer may be transmitted. In step 12, it is determined to perform UE-satellite-UE communication and an IMS-AGW on the satellite may be selected. In steps 12a and 12b, allocation request and reservation (Reserved) may be performed. In step 12c, IMS-AGW A′ on the ground may be released. In step 13, QoS resources may be authorized and an UL CL/BP and an L-PSA may be inserted on the satellite.

In steps 14 to 16, response confirmation (Conf) and response confirmation (Conf) with a modified SDP may be exchanged. In step 17, an IMS-AGW on the satellite may be updated. In steps 17a and 17b, allocation request (Req.) and reservation (Reserved) may be performed. In step 18, response confirmation (Conf) may be completed. In step 19, a secure procedure may be performed to complete the session establishment.

However, the existing procedure illustrated in FIG. 2 is for an IMS based service and essentially requires SIP signaling and a complex interaction with IMS core network elements. Thus, the existing procedure is not suitable for direct communication between UEs for a non-IMS service via an Internet protocol (IP) or Ethernet based protocol data unit (PDU) session, for example, a 5G-LAN service due to excessive signaling overhead, structural inefficiency, and reliance on complex IMS core interactions.

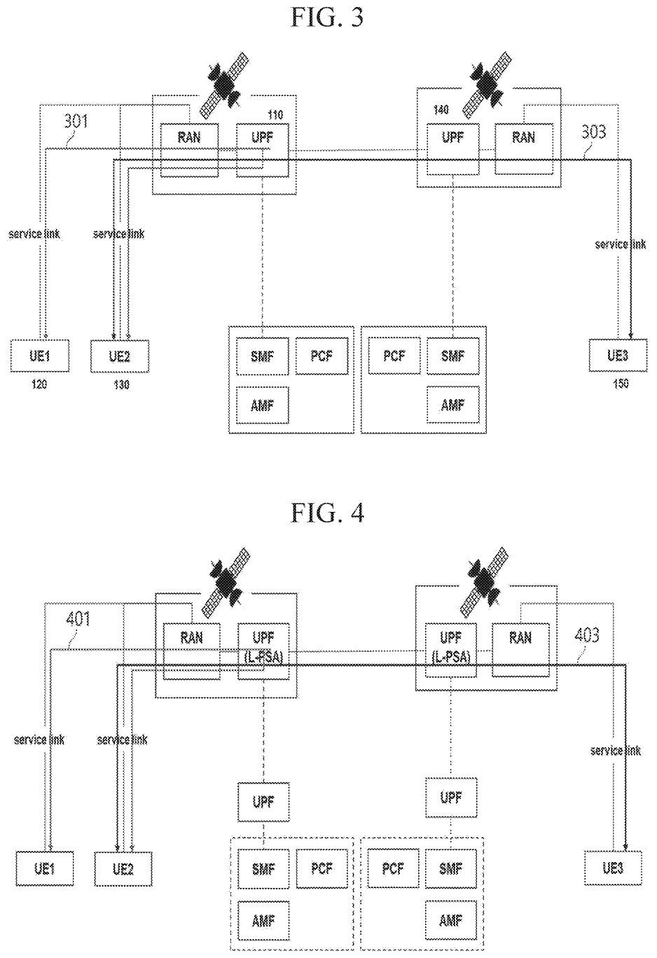

FIG. 3 illustrates a schematic diagram of a system for processing user plane traffic between pieces of user equipment (UEs) using a user plane function (UPF) in a satellite according to an embodiment of the present disclosure.

Referring to FIG. 3, a communication system may include a first satellite 110, a second satellite 140, and terrestrial network elements. A radio access network (RAN) and a UPF may be onboard the first satellite 110. A UPF and a RAN may be onboard the second satellite 140. A terrestrial network may include a session management function (SMF), a policy control function (PCF), and an access and mobility management function (AMF).

A first UE (UE1) 120 and a second UE (UE2) 130 may access the first satellite 110 via a service link. A third UE (UE3) 150 may access the second satellite 140 via a service link.

A first path 301 may indicate a communication path between UEs in the same satellite. When UE1 120 and UE2 130 access the same first satellite 110, user plane traffic may be terminated in a local switching scheme in the UPF onboard the first satellite 110. In this case, the UPF may operate as a protocol data unit (PDU) session anchor (PSA) may directly deliver traffic between UE1 120 and UE2 130 via an Internet protocol or Ethernet based PDU session without passing through a terrestrial data network (DN) or an Internet protocol multimedia subsystem (IMS).

A second path 303 may indicate a UE communication path between different satellites. When UE2 130 accesses the first satellite 110 and UE3 150 accesses the second satellite 140, user plane traffic may be delivered via an N19 interface between the UPF onboard the first satellite 110 and the UPF onboard the second satellite 140 or an inter-satellite link (ISL). The SMF may separately establish each PSA with regard to the UPF connection structure between the two satellites or may apply a multi-anchor PSA configuration.

The structure according to the present disclosure may use the UPF onboard the satellite as the PSA to perform direct communication between UEs for a non-IMS service without passing through a terrestrial network, thus minimizing latency and solving a traffic bottleneck phenomenon.

Communication processing between UEs when using the UPF onboard the satellite as the PSA follows the following procedure. First, the SMF may specify a PSA UPF as a UPF in the satellite, on the basis of location information of the UE and a DNAI corresponding to data network name/single network slice selection assistance information (DNN/S-NSSAI). Secondly, the PSA UPF in the satellite may perform a 5G VN internal interface-based traffic classification and reforwarding procedure. This may include a process for classifying incoming traffic using a GTP-U header-based PDR and a process for passing through an internal interface and performing a downlink PDR based on a destination address. Finally, communication between UEs in the same PSA UPF may be processed in a local switching scheme and an N19 tunnel may be established between PSA UPFs on different satellites.

FIG. 4 illustrates a schematic diagram of a system for processing user plane traffic between local protocol data unit (PDU) session anchors (L-PSAs) according to an embodiment of the present disclosure.

Referring to FIG. 4, a communication system may include a first satellite, a second satellite, and terrestrial network elements. A radio access network (RAN) and a user plane function (UPF) which operates as an L-PSA may be onboard the first satellite. A UPF which operates as an L-PSA and a RAN may be onboard the second satellite. A terrestrial network may include a UPF, a session management function (SMF), a policy control function (PCF), and an access and mobility management function (AMF). The UPF located on the ground may be a PDU session anchor (PSA), which may maintain and manage an Internet protocol (IP) address of user equipment (UE).

A first UE UE1 and a second UE UE2 may access the first satellite via a service link. A third UE UE3 may access the second satellite via a service link.

A first path 401 may indicate a communication path between UEs in the same satellite. When UE1 and UE2 access the same first satellite, user plane traffic may directly switch in a local switching scheme in an L-PSA UPF onboard the first satellite. In this case, the traffic may be terminated in the satellite without passing through the terrestrial PSA UPF. A terrestrial PSA may only play a role in maintaining IP continuity of the UE.

A second path 403 may indicate a UE communication path between different satellites. When UE2 accesses the first satellite and UE3 accesses the second satellite, user plane traffic may be delivered via an N6 or N19 interface between an L-PSA UPF onboard the first satellite and an L-PSA UPF onboard the second satellite. The SMF may establish a group-level N4 session between the respective L-PSA UPFs to process traffic between UEs which belong to the same 5G virtual network (VN) group.

In detail, when N19 based forwarding for communication between satellites is performed, UPFs may be onboard a plurality of satellites, respectively. The SMF may establish a group-level N4 session between the respective UPFs to process traffic between UEs which belong to the same 5G VN group. The SMF may release an existing UPF if necessary, may update the existing UPF to a new satellite UPF, and may update a related N4 rule and N19 tunnel information. An internal processing structure of a satellite based PSA UPF may forward traffic using a 5G VN internal interface.

For local switching in the PSA UPF in the same satellite, traffic between PDU sessions which are present on the same PSA UPF may be processed in a local switching scheme via an internal interface and may be forwarded based on a GTP-U header and a destination address.

For N19 based forwarding between multiple satellites, traffic between UEs anchored at different PSA UPFs may be transmitted via an N19 tunnel and may be processed according to the group-level N4 session. The SMF may set a PDR and an FAR between the respective UPFs and may deliver a destination address based packet to a counterpart UPF.

The structure according to the present disclosure may perform local switching via an L-PSA onboard the satellite, while maintaining IP continuity via a terrestrial PSA, to provide direct communication between UEs for a non-Internet protocol multimedia subsystem (IMS) service without a session disconnection even in a mobility environment of a non-geostationary satellite orbit (NGSO) satellite.

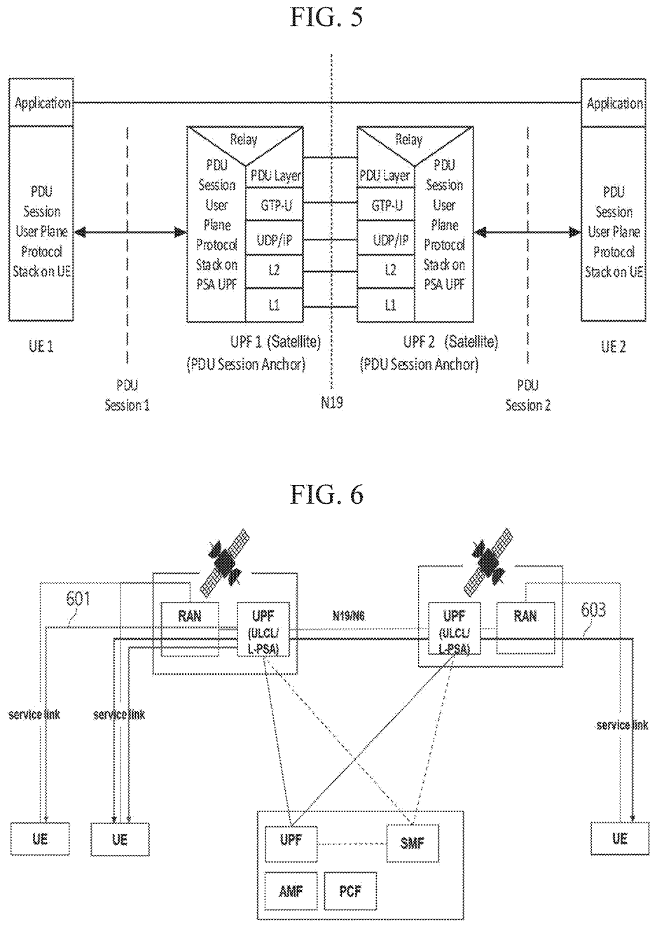

FIG. 5 illustrates a protocol stack structure between protocol data unit (PDU) session anchor (PSA) user plane functions (UPFs) onboard satellites for N19 based forwarding according to an embodiment of the present disclosure.

Referring to FIG. 5, first user equipment (UE) UE 1 and a second UE UE 2 may perform communication using UPFs onboard different satellites. UE 1 may be connected with UPF 1 (Satellite) onboard a first satellite via PDU session 1 and UE 2 may be connected with UPF 2 (Satellite) onboard a second satellite via PDU session 2. UPF 1 and UPF 2 may operate as PSAs, respectively.

Each of UE 1 and UE 2 may include an application layer and a PDU session user plane protocol stack on UE. Each of UPF 1 and UPF 2 onboard the satellites may include a relay module, a PDU session user plane protocol stack on PSA UPF, a PDU layer, a GPRS tunneling protocol-user plane (GTP-U), a user datagram protocol/Internet protocol (UDP/IP), layer 2 (L2), and layer 1 (L1).

UPF 1 and UPF 2 may be connected via an N19 interface. The N19 interface may be composed of a shared user plane tunnel. Traffic delivery via the N19 interface may be performed via a UDP/IP based GTP-U encapsulation structure. The relay module of each UPF may perform a function for delivering received traffic to a counterpart UPF or forwarding the received traffic to a local UE.

According to the present structure, user plane traffic transmitted from UE 1 may be received from UPF 1 via PDU session 1 and may be delivered to the N19 interface via the relay module. The traffic may be encapsulated via the GTP-U, the UDP/IP, the L2, and the L1 to be transmitted to UPF 2. UPF 2 may decapsulate the traffic and may deliver the traffic to UE 2 via PDU session 2. As a result, real-time low-latency communication between the PSA UPFs onboard the satellites may be realized.

FIG. 6 illustrates a non-geostationary satellite orbit (NGSO) satellite based local switching structure according to an embodiment of the present disclosure.

Referring to FIG. 6, a communication system may include a first satellite, a second satellite, and terrestrial network elements. A radio access network (RAN) and a user plane function (UPF) including an uplink classifier (UL CL) and a local protocol data unit (PDU) session anchor (L-PSA) may be onboard each of the first satellite and the second satellite. A terrestrial network may include a UPF which operates as a PDU session anchor (PSA), a session management function (SMF), an access and mobility management function (AMF), and a policy control function (PCF).

A PSA UPF located on the ground may allocate and maintain an Internet protocol (IP) address of user equipment (UE) and may ensure IP continuity. A connection via an N19 or N6 interface may be established between the UPFs onboard the two satellites.

A first path 601 may indicate a communication path between UEs in the same satellite. When two UEs access the same first satellite, the UL CL may analyze a destination IP address upward received from a first UE. When the destination IP address is identical to a second UE in a predefined 5G virtual network (VN) group, the UL CL may branch a packet to the L-PSA and the L-PSA may directly deliver traffic to the second UE in a local switching scheme. When the destination IP address does not correspond to a UE in the group, the packet may be delivered to a terrestrial PSA UPF.

A second path 603 may indicate a UE communication path between different satellites. When the first UE accesses the first satellite and a third UE accesses the second satellite, user plane traffic may be delivered via an N19 or N6 interface between the L-PSA UPF onboard the first satellite and the L-PSA UPF onboard the second satellite. The SMF may verify whether the satellite pair is interconnectable with reference to an inter-satellite link configuration and may establish a tunnel between the respective L-PSAs.

When a service satellite changes due to satellite mobility or a handover of the UE, the AMF may report a new satellite ID or a data network access identifier (DNAI) to the SMF. The SMF may release existing L-PSA and UL CL resources and may re-establish an L-PSA and a UL CL in a new satellite.

In the structure illustrated in FIG. 6, a dynamic tunnel establishment and release method based on the N6 or N19 interface between the L-PSA UPFs between NGSO satellites may include the following steps.

In a first step, when the two UEs access the different NGSO satellites, the UPF which plays a role as an L-PSA may be onboard each satellite.

In a second step, the SMF may detect a direct communication requirement between the two UEs via an AF request or an analysis of a destination IP address of an uplink packet.

In a third step, the AMF may deliver an identifier of the satellite each UE is currently accessing to the SMF.

In a fourth step, the SMF may verify whether the satellite pair is interconnectable with reference to the inter-satellite link configuration which is previously configured and may perform one of an N6 based connection or an N19 based connection. The N6 based connection is a scheme for establishing a tunneling path via the N6 interface, when it is possible to perform IP based routing between the two satellites. The N19 based connection is a scheme for a group-level N4 session configuration and tunnel establishment via the N19 interface, when under the same SMF control.

In a fifth step, the tunnel between the satellites may directly deliver user plane data between the L-PSA UPFs. Thereafter, the packet between the UEs may be directly delivered over a satellite network without passing through the terrestrial PSA.

In a sixth step, when the connected satellite changes due to movement of the UE or the satellite, the AMF may deliver a new satellite identifier to the SMF. The SMF may remove an existing tunnel and may establish a new tunnel or may switch to a terrestrial PSA path.

As the PSA is maintained on the ground, the IP session may fail to be terminated and only satellite based resources may be dynamically reconfigured.

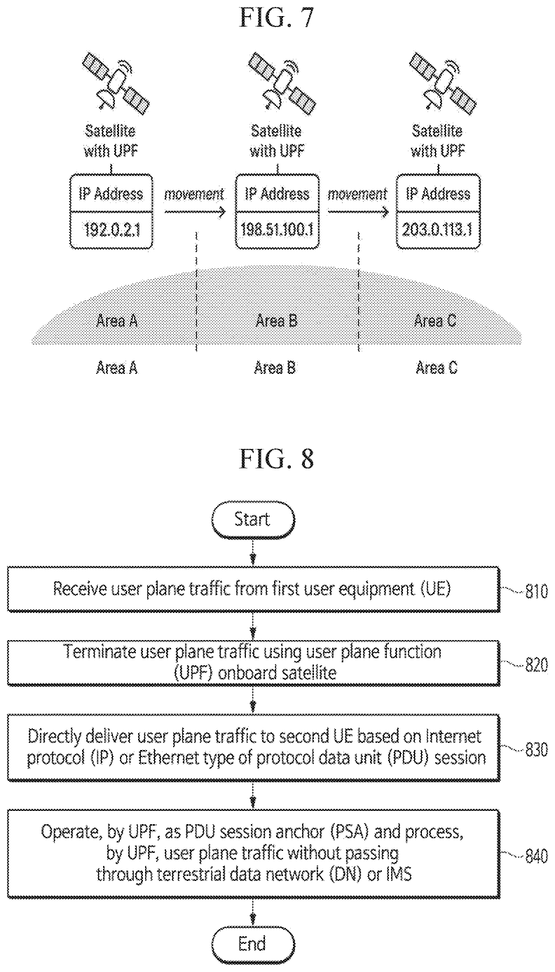

FIG. 7 illustrates a location based fixed Internet protocol (IP) address allocation structure according to an embodiment of the present disclosure.

Referring to FIG. 7, a structure in which a satellite with a user plane function (UPF) sequentially covers different geographical areas while moving along the orbit. Terrestrial coverage may be divided into a plurality of location areas, for example, area A, area B, and area C.

A logical IP address may be mapped to each location area in advance. An IP address of 192.0.2.1 may be allocated to area A, an IP address of 198.51.100.1 may be allocated to area B, and an IP address of 203.0.113.1 may be allocated to area C.

The UPF onboard the satellite may calculate a geographical area which is currently covered by the UPF in real time and may automatically obtain or maintain the IP address allocated to the area. For example, when the satellite covers area A, the UPF may use the IP address of 192.0.2.1. When the satellite moves and covers area B, the UPF may obtain the IP address of 198.51.100.1. When the satellite covers area C, the UPF may obtain the IP address of 203.0.113.1.

Although the satellite moves via such a location based IP address allocation structure, a terrestrial radio access network (RAN) or user equipment (UE) may maintain an existing routing path. When the satellite moves to an adjacent area to enter another location area, a new IP address allocated in advance may be obtained and an N4/N6 path may be reconfigured without a session disconnection. A session management function (SMF) or an operations, administration, and maintenance (OAM) system may control the IP address change and may maintain protocol data unit (PDU) session state information to prevent a traffic disconnection.

FIG. 8 illustrates a flowchart of an operating method of a satellite for supporting communication between pieces of user equipment (UEs) for a non-Internet protocol multimedia subsystem (IMS) in a wireless communication system according to an embodiment of the present disclosure.

Referring to FIG. 8, the operating method of the satellite may include a step 810, a step 820, a step 830, and a step 840.

In the step 810, the satellite may receive user plane traffic from first user equipment (UE). The first UE may access the satellite via a service link. The user plane traffic may be transmitted via an Internet protocol (IP) or Ethernet based protocol data unit (PDU) session.

In the step 820, the satellite may terminate the user plane traffic using a user plane function (UPF) onboard the satellite. The UPF onboard the satellite may analyze the received traffic, may identify a destination UE, and may determine an appropriate forwarding path.

In an embodiment, when the first UE and a second UE access the same satellite, the user plane traffic may be terminated in a local switching scheme in the UPF. In the local switching scheme, the UPF may classify incoming traffic using a GPRS tunneling protocol-user plane (GTP-U) header-based packet detection rule (PDR), may pass the traffic through a 5G virtual network (VN) internal interface, and may perform a downlink PDR based on the destination address to deliver the traffic to the second UE. in another embodiment, when the first UE and the second UE access different satellites, user plane traffic may be delivered via an N19 interface between a UPF onboard the satellite and a UPF onboard the other satellite. The N19 interface may be configured as a shared user plane tunnel and may deliver traffic between a plurality of PDU sessions via user datagram protocol (UDP)/IP based GTP-U encapsulation. Each UPF may include a relay module. The relay module may perform a function for delivering received traffic to a counterpart UPF or forwarding the received traffic to a local UE.

In the step 830, the satellite may directly deliver the user plane traffic to the second UE based on an IP or Ethernet type of PDU session. The PDU session may provide a communication path for a non-IMS service, such as a 5G-LAN and may facilitate direct communication between UEs without signaling with IMS core network elements.

In the step 840, the UPF may operate as a PDU session anchor (PSA) and may process the user plane traffic without passing through a terrestrial data network (DN) or an IMS. The UPF which operates as the PSA may play a role as a termination point of the PDU session. All pieces of user plane traffic may end in the satellite.

In an embodiment, an IP address of the UPF onboard a satellite may be predefined as a location-based logical address mapped to predefined geographical regions, thereby enabling seamless session continuity through automatic IP reassignment during satellite movement without session disconnection. A terrestrial network may divide the entire coverage in units of certain locations and may map a logical IP address block to each location in advance. The UPF onboard the satellite may calculate a geographical area which is currently covered by the UPF in real time and may automatically obtain the IP address allocated to the area. As a result, as the IP address mapped to the location is automatically allocated to the UPF along the movement path of the satellite, a routing path among a terminal, a radio access network (RAN), and a core network may be fixed. When the satellite moves to an adjacent area to enter another location area, a new IP address allocated in advance may be obtained and an N4/N6 path may be reconfigured without a session disconnection.

The operating method of the satellite according to the present disclosure may use the UPF onboard the satellite as the PSA to perform direct communication between UEs for the non-IMS service, thus minimizing latency and solving a traffic bottleneck phenomenon.

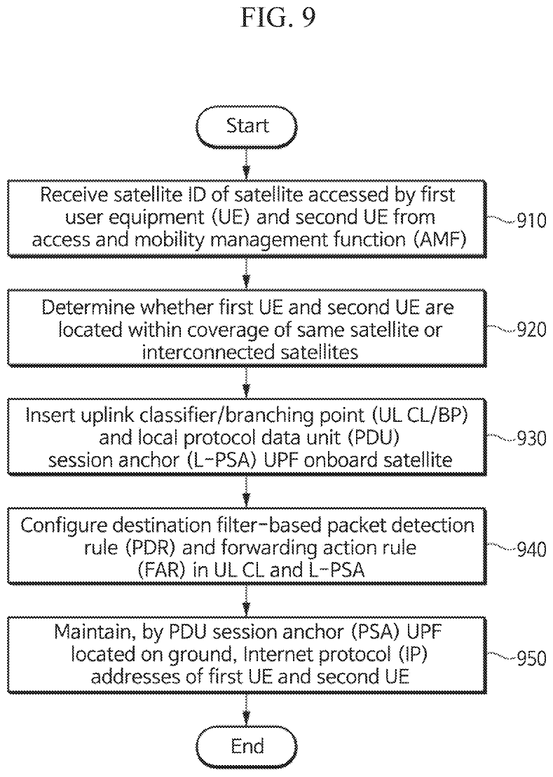

FIG. 9 illustrates a flowchart of an operating method of a session management function (SMF) for supporting communication between pieces of user equipment (UEs) for a non-Internet protocol multimedia subsystem (IMS) in a wireless communication system according to an embodiment of the present disclosure.

Referring to FIG. 9, the operating method of the SMF may include a step 910, a step 920, a step 930, a step 940, and a step 950.

In the step 910, the SMF may receive a satellite ID of a satellite accessed by first user equipment (UE) and a second UE from an access and mobility management function (AMF). The AMF may report the satellite ID with which each UE is connected and data network access identifier (DNAI) information to the SMF.

In an embodiment, the SMF may receive a communication request between UEs from an application function (AF) or destination Internet protocol (IP) address information observed from a protocol data unit (PDU) session anchor (PSA) user plane function (UPF) and may detect a direct communication requirement between the two UEs.

In the step 920, the SMF may determine whether the first UE and the second UE are located within coverage of the same satellite or interconnected satellites. The SMF may verify whether the satellite pair is interconnectable with reference an inter-satellite link configuration which is configured in advance.

In an embodiment, when the first UE and a second UE access the same satellite, the SMF may determine to perform local switching in the satellite. In another embodiment, when the first UE and the second UE access different satellites, the SMF may determine whether it is possible to establish a tunnel via an N6 or N19 interface between the two satellites. The N6 based connection may be applied when it is possible to perform IP based routing between the two satellites. The N19 based connection may be applied when under the same SMF control.

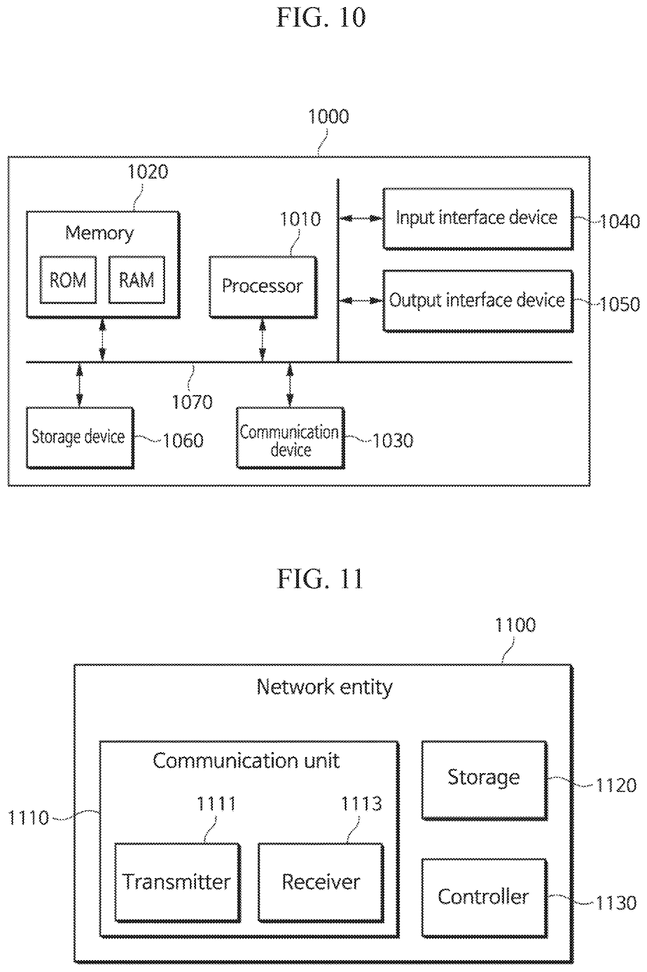

FIG. 10 illustrates a configuration of a satellite according to an embodiment of the present disclosure.

Referring to FIG. 10, a satellite 1000 may include at least one processor 1010, a memory 1020, and a transceiver 1030 connected with a network to perform communication. Furthermore, the satellite 1000 may further include an input interface device 1040, an output interface device 1050, a storage device 1060, and the like. The respective components included in the satellite 1000 may be connected with each other by a bus 1070 to communicate with each other.

However, the respective components included in the satellite 1000 may be connected with each other via an individual interface or an individual bus around the processor 1010, rather than the common bus 1070. For example, the processor 1010 may be connected with at least one of the memory 1020, the transceiver 1030, the input interface device 1040, the output interface device 1050, and the storage device 1060 via a dedicated interface.

The processor 1010 may execute a program command stored in at least one of the memory 1020 and the storage device 1060. The processor 1010 may refer to a central processing unit (CPU), a graphics processing unit (GPU), or a dedicated processor in which methods according to embodiments of the present disclosure are performed. Each of the memory 1020 and the storage device 1060 may be composed of at least one of a volatile storage medium and a non-volatile storage medium. For example, the memory 1020 may be composed of at least one of a read only memory (ROM) and a random access memory (RAM).

The transceiver 1030 may perform wireless communication via a service link with user equipment (UE), communication via an inter-satellite link (ISL) with another satellite, and communication via a feeder link with a terrestrial gateway.

The processor 1010 may execute a user plane function (UPF) onboard a satellite, may receive user plane traffic from a first UE, may terminate the user plane traffic, and may directly deliver the user plane traffic to a second UE based on an Internet protocol (IP) or Ethernet type of protocol data unit (PDU) session. The UPF may operate as a PDU session anchor (PSA) and may process the user plane traffic without passing through a terrestrial data network (DN) or an Internet protocol multimedia subsystem (IMS).

FIG. 11 illustrates a configuration of a network entity including a session management function (SMF) in a wireless communication system according to various embodiments of the present disclosure.

The network entity of the present disclosure is a concept including a network function depending on system implementation. The term “~unit” and “~er” used hereinafter may refer to a unit for processing at least one function or operation. This may be implemented with hardware, software, or a combination thereof.

Referring to FIG. 11, a network entity 1100 according to various embodiments of the present disclosure may include a communication unit 1110, storage 1120, and a controller 1130 for controlling the overall operation of the network entity 1100.

The communication unit 1110 may transmit and receive a signal with other network entities. Thus, all or a part of the communication unit 1110 may be referred to as a “transmitter 1111”, a “receiver 1113”, or a “transceiver 1110”.

The storage 1120 may store a default program, an application program, and data, such as configuration information, for an operation of the network entity 1100. The memory 1120 may be composed of a volatile memory, a non-volatile memory, or a combination thereof. The storage 1120 may provide the stored data depending on the request of the controller 1130.

The controller 1130 may control the overall operations of the network entity 1100. For example, the controller 1130 may transmit and receive a signal via the communication unit 1110. Furthermore, the controller 1130 may record and read data from the storage 1120. The controller 1130 may perform functions of a protocol stack, which are required in the communication specification. To this end, the controller 1130 may include a circuit, an application-specific circuit, at least one processor, or a microprocessor or may be a part of the processor. Furthermore, a part of the communication unit 1110 and the controller 1130 may be referred to as a communication processor (CP).

The controller 1130 may control the network entity 1100 to perform an operation of any one of various embodiments of the present disclosure. It is obvious that the communication unit 1110 and the controller 1130 do not necessarily have to be implemented as separate modules and may be implemented as one configuration unit in the form of a single chip or a software block. The communication unit 1110, the storage 1120, and the controller 1130 may be electrically connected with each other. Furthermore, the operations of the network entity 1100 may be realized by including the storage 1120 which stores a corresponding program code in the network entity 1100.

The network entity 1100 may include a network node and may be any one of a radio access network (RAN), an access and mobility management function (AMF), an SMF, a user plane function (UPF), a network function (NF), a network exposure function (NEF), a network repository function (NRF), a charging function (CF), a network slice selection function (NSSF), unified data management (UDM), an application function (AF), an authentication server function (AUSF), a service communication proxy (SCP), an unstructured data storage function (UDSF), context storage, operations, administration, and maintenance (OAM), an element management system (EMS), a configuration server, and an identifier (ID) management server.

When the network entity 1100 operates as the SMF, the controller 1130 may receive a satellite ID of a satellite accessed by first user equipment (UE) and a second UE from an AMF, may determine whether the first UE and the second UE are located within coverage of the same satellite or interconnected satellites, may insert an uplink classifier/branching point (UL CL/BP) and local protocol data unit (PDU) session anchor (L-PSA) UPF onboard the satellite, and may configure a destination filter-based packet detection rule (PDR) and a forwarding action rule (FAR) in a UL CL and an L-PSA. A PDU session anchor (PSA) UPF located on the ground may maintain Internet protocol (IP) addresses of the first UE and the second UE.

Methods according to claims of the present disclosure or embodiments described in the specification may be implemented in the form of hardware, software, or a combination thereof.

When they are implemented with software, a computer-readable storage medium for storing one or more programs (or software modules) may be provided. The one or more programs stored in the computer-readable storage medium are configured to be executable by one or more processors in an electronic device. The one or more programs include instructions causing the electronic device to execute methods according to the claims of the present disclosure or the embodiments described in the specification.

Such a program (or a software module or software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs) or an another type of optical storage device, or a magnetic cassette. Alternatively, the program may be stored in a memory configured as a combination of some or all thereof. Furthermore, each configuration memory may be included in plural.

Furthermore, the program may be stored in an attachable storage device accessible over a communication network, such as the Internet, an intranet, a local area network (LAN), a wide area network (WAN), or a storage area network (SAN), or a communication network composed of a combination thereof. Such a storage device may access a device for performing an embodiment of the present disclosure via an external port. Furthermore, a separate storage device on the communication network may access a device for performing an embodiment of the present disclosure.

In detailed embodiments of the above-mentioned present disclosure, a component included in the present disclosure is expressed in a singular or plural form according to the proposed detailed embodiment. However, the expression in the singular or plural form is selected to be suitable for a situation proposed for convenience of description. The present disclosure is not limited to a singular component or a plurality of components. Even components expressed in the plural form may be configured in the singular form, but a component expressed in the singular form may be configured in the plural form.

The apparatus and the method according to various embodiments of the present disclosure may terminate user plane traffic without passing through a terrestrial network using a user plane function onboard a satellite, thus minimizing latency in a satellite communication environment, solving a traffic bottleneck phenomenon, and providing low-latency and high-availability communication across diverse environments, including maritime, aviation, space, and military communication scenarios.

Furthermore, the apparatus and the method according to various embodiments of the present disclosure may provide a 5G-LAN service which does not pass through an Internet protocol multimedia subsystem (IMS) using an IP or Ethernet based on a protocol data unit (PDU) session, thus realizing low-latency and high-availability communication in various closed-network environments, such as marine, aviation, space communication, military communication.

Furthermore, the apparatus and the method according to various embodiments of the present disclosure may simultaneously perform IP continuity maintenance via a terrestrial PDU session anchor (PSA) and local switching via a local PSA (L-PSA) onboard the satellite, thus providing stable communication between UEs without a session disconnection even in a mobility environment of a non-geostationary satellite orbit (NGSO) satellite.

The effects that are achieved through the present disclosure may not be limited to the effects described above, and other advantages not described above may be more clearly understood from the following detailed description by those skilled in the art to which the present disclosure pertains.

Meanwhile, while the present disclosure has been described with reference to detailed embodiments, it will be apparent that various changes and modifications may be made without departing from the spirit and scope of the present disclosure. Therefore, the spirit and scope of the present disclosure is not limited and determined by the described embodiment and should be determined by the scope and equivalents of the claims as well as the scope of the claims which will be described below.

What is claimed is:

1. An operating method of a satellite for supporting communication between pieces of user equipment (UEs) for a non-Internet protocol multimedia subsystem (IMS) service in a wireless communication system, the operating method comprising:
receiving user plane traffic from first user equipment (UE);
terminating the user plane traffic using a user plane function (UPF) onboard the satellite; and
directly delivering the user plane traffic to a second UE based on an Internet protocol (IP) or Ethernet type of protocol data unit (PDU) session,
wherein the satellite processes the user plane traffic without passing through a terrestrial data network (DN) or an IMS.

2. The operating method of claim 1, wherein the UPF operates as a PDU session anchor (PSA), and
wherein the user plane traffic is terminated in a local switching scheme in the UPF, when the first UE and the second UE access the same satellite.

3. The operating method of claim 1, wherein the user plane traffic is delivered via an N19 interface between a UPF onboard the satellite and a UPF onboard the other satellite, when the first UE and the second UE access the different satellites.

4. The operating method of claim 3, wherein the N19 interface is configured as a shared user plane tunnel and delivers traffic between a plurality of PDU sessions via user datagram protocol (UDP)/IP based GPRS tunneling protocol-user plane (GTP-U) encapsulation.

5. The operating method of claim 1, wherein a routing path among a terminal, a radio access network (RAN), and a core network is fixed, as an IP address of the UPF is predefined as a location based logical address of the satellite and an IP address mapped to a corresponding location is automatically allocated to the UPF along a movement path of the satellite.

6. An operating method of a session management function (SMF) for supporting communication between pieces of user equipment (UEs) for a non-Internet protocol multimedia subsystem (IMS) service in a wireless communication system, the operating method comprising:
receiving a satellite ID of a satellite accessed by first user equipment (UE) and a second UE from an access and mobility management function (AMF);
determining whether the first UE and the second UE are located within coverage of the same satellite or interconnected satellites;
inserting an uplink classifier/branching point (UL CL/BP) and local protocol data unit (PDU) session anchor (L-PSA) user plane function (UPF) onboard the satellite; and
configuring a destination filter-based packet detection rule (PDR) and a forwarding action rule (FAR) in a UL CL and an L-PSA,
wherein a PDU session anchor (PSA) UPF located on the ground maintains Internet protocol (IP) addresses of the first UE and the second UE.

7. The operating method of claim 6, wherein the UL CL analyzes a destination IP address of a packet upward received from the first UE and delivers the packet to the L-PSA, when the destination IP address is identical to the second UE in a predefined 5G virtual network (VN) group.

8. The operating method of claim 6, wherein the L-PSA directly switches traffic between the first UE and the second UE in a local switching scheme, when the first UE and the second UE access the same satellite.

9. The operating method of claim 6, wherein a tunnel is established via an N6 or N19 interface between L-PSAs onboard respective satellites to deliver user plane traffic, when the first UE and the second UE access the different satellites.

10. The operating method of claim 6, further comprising:
receiving a new satellite identifier or a data network access identifier (DNAI) from the AMF and re-establishing an L-PSA and a UL CL in a new satellite, when a service satellite changes due to satellite mobility or a handover of the first UE.

11. A satellite for supporting communication between pieces of user equipment (UEs) for a non-Internet protocol multimedia subsystem (IMS) service in a wireless communication system, the satellite comprising:
a transceiver; and
a processor operatively connected with the transceiver,
wherein the processor is configured to:
receive user plane traffic from first user equipment (UE);
terminate the user plane traffic using a user plane function (UPF) onboard the satellite; and
directly deliver the user plane traffic to a second UE based on an Internet protocol (IP) or Ethernet type of protocol data unit (PDU) session,
wherein the UPF operates as a PDU session anchor (PSA) and processes the user plane traffic without passing through a terrestrial data network (DN) or an IMS.

12. The satellite of claim 11, wherein the processor is configured to terminate the user plane traffic in a local switching scheme in the UPF, when the first UE and the second UE access the same satellite.

13. The satellite of claim 11, wherein the processor is configured to deliver the user plane traffic via an N19 interface between a UPF onboard the satellite and a UPF onboard the other satellite, when the first UE and the second UE access the different satellites.

14. The satellite of claim 13, wherein the N19 interface is configured as a shared user plane tunnel and delivers traffic between a plurality of PDU sessions via user datagram protocol (UDP)/IP based GPRS tunneling protocol-user plane (GTP-U) encapsulation.

15. The satellite of claim 11, wherein a routing path among a terminal, a radio access network (RAN), and a core network is fixed, as an IP address of the UPF is predefined as a location based logical address of the satellite and an IP address mapped to a corresponding location is automatically allocated to the UPF along a movement path of the satellite.

16. A session management function (SMF) for supporting communication between pieces of user equipment (UEs) for a non-Internet protocol multimedia subsystem (IMS) service in a wireless communication system, the SMF comprising:
a transceiver; and
a processor operatively connected with the transceiver,
wherein the processor is configured to:
receive a satellite ID of a satellite accessed by first user equipment (UE) and
a second UE from an access and mobility management function (AMF);
determine whether the first UE and the second UE are located within coverage of the same satellite or interconnected satellites;
insert an uplink classifier/branching point (UL CL/BP) and local protocol data unit (PDU) session anchor (L-PSA) user plane function (UPF) onboard the satellite; and
configure a destination filter-based packet detection rule (PDR) and a forwarding action rule (FAR) in a UL CL and an L-PSA,
wherein a PDU session anchor (PSA) UPF located on the ground maintains Internet protocol (IP) addresses of the first UE and the second UE.

17. The SMF of claim 16, wherein the processor is configured to analyze a destination IP address of a packet upward received from the first UE and deliver the packet to the L-PSA in the UL CL, when the destination IP address is identical to the second UE in a predefined 5G virtual network (VN) group.

18. The SMF of claim 16, wherein the processor is configured to directly switch traffic between the first UE and the second UE in a local switching scheme in the L-PSA, when the first UE and the second UE access the same satellite.

19. The SMF of claim 16, wherein the processor is configured to establish a tunnel via an N6 or N19 interface between L-PSAs onboard respective satellites to deliver user plane traffic, when the first UE and the second UE access the different satellites.

20. The SMF of claim 16, wherein the processor is configured to receive a new satellite identifier or a data network access identifier (DNAI) from the AMF and re-establish an L-PSA and a UL CL in a new satellite, when a service satellite changes due to satellite mobility or a handover of the first UE.
